(19) United States
(12) Patent Application Publication
(10) Pub. No.: US 2005/0008173 A1
(43) Pub. Date: Jan. 13, 2005

(54) Speaker system

(76) Inventors: Ryuji Suzuki, Tokyo (JP); Michie Sato, Tokyo (JP); Ryuichi Tanaka, Kanagawa (JP); Tsutomu Shoji, Kanagawa (JP); Noboru Shuhama, Tokyo (JP)

Correspondence Address: FROMMER LAWRENCE & HAUG LLP, 745 FIFTH AVENUE, NEW YORK, NY, 10151, US

(21) Appl. No.: 10/844,032

(22) Filed: May 11, 2004

(30) Foreign Application Priority Data
May 13, 2003 (JP) 2003-135102

(51) Int. Cl. H04R 1/02; H04R 25/00

(52) U.S. Cl. 381/160; 381/337; 381/339

(57) ABSTRACT

A speaker system enabling efficient dispersion of intelligible sound far in all directions from a specific point along a certain planar direction, provided with a single speaker, a first reflective (directing) surface arranged facing a sound output direction of the speaker and reflecting the sound to directions different from the output direction, and a second reflective (directing) surface arranged facing the first reflective surface, wherein the distance between the first reflective surface and the second reflective surface increases continuously in proportion to the distance from the center of the speaker and wherein the first reflective surface and the second reflective surface diffuse sound radially from the speaker to directions different to the sound output direction of the speaker.

### BACKGROUND OF THE INVENTION

1. Field of the Invention

The present invention relates to a speaker system.

2. Description of the Related Art

For example, in order to disperse sound from a certain position in all directions along a substantially horizontal direction, it is required to position a plurality of speakers to face different directions. If positioning a plurality of speakers to face different directions, however, interference will occur among the sounds output from the different speakers. As a result, there will be places where the sound is heard strongly and places where it is heard weakly. Therefore, when using a plurality of speakers, effective dispersion of sound is difficult.

Japanese Unexamined Patent Publication (Kokai) No. 2003-87887 discloses the technique of capturing speech of a participant in a conference by a microphone and dispersing it over a wide area by using a single speaker and a reflective plate. In this technique for dispersing speech captured by a microphone over wide area using a single speaker and a reflective plate, since a single speaker is used, the speech has to be dispersed efficiently.

To efficiently disperse sound far, a horn-shaped speaker box, for example, can be applied. However, resonance easily occurs in the range of transmission frequency of speech. If resonance occurs in the range of transmission frequency of speech from a single speaker, the sound will be very unintelligible and will not be able to be dispersed far.

### SUMMARY OF THE INVENTION

An object of the present invention is to provide a speaker system enabling efficient dispersion of intelligible sound far in all directions from a specific point along a certain planar direction.

According to the present invention, there is provided a speaker system comprising a single speaker and a dispersing means for dispersing sound radially and evenly from the speaker to directions different from the direction of output of sound of the speaker.

Preferably, the dispersing means has a first sound directing surface including a concave contour portion perpendicular to the center of the speaker and a flat peripheral portion extending to the end of the concave contour portion, facing the direction of output of sound from the speaker and a second sound directing surface arranged facing the first sound directing surface to thereby direct sound to a direction perpendicular to that of the center of the sound output direction of the speaker by cooperating with the first sound directing means.

More preferably, the distance between the first sound directing surface and the second sound directing surface increases continuously along the position from the center of said speaker to the end of the surfaces.

According to the present invention, the dispersing means disperses the sound of the speaker radially and evenly from the speaker in directions different from the direction of output of sound from the speaker. At this time, the sound output from the single speaker is repeatedly reflected between the first sound directing surface and the second sound directing surface of the dispersing means. The sound repeatedly reflected between the first sound directing surface and the second sound directing surface is resistant to resonance since the distance between the first sound directing surface and the second sound directing surface continuously along the position from the center of said speaker to the end of the surfaces.

Therefore, according to the present invention, it becomes possible to efficiently disperse intelligible sound far in all directions from a specific point along a specific planar direction.

### BRIEF DESCRIPTION OF THE DRAWINGS

The above and other objects and features of the present invention will be described in more detail with reference to the accompanying drawings, in which:

FIG. 1 is a perspective view of an exterior appearance of a speaker system according to an embodiment of the present invention;

FIG. 2 is a plan view of the structure of a printed circuit board held by a holding member;

FIG. 3 is a cross-sectional view of the internal structure of a speaker system according to an embodiment of the present invention;

FIG. 4 is a view for describing the positional relation between a reflective surface of a holding member side and a reflective surface of a speaker box side;

FIGS. 5A and 5B are views of an example of vibration of a speaker box;

FIGS. 6A and 6B are views of an example of vibration of a speaker box in case of no connection bolts; and

FIG. 7 is a cross-sectional view showing an operation of a filter member.

### DESCRIPTION OF THE PREFERRED EMBODIMENTS

Hereinafter, an embodiment of the present invention will be described with reference to the drawings.

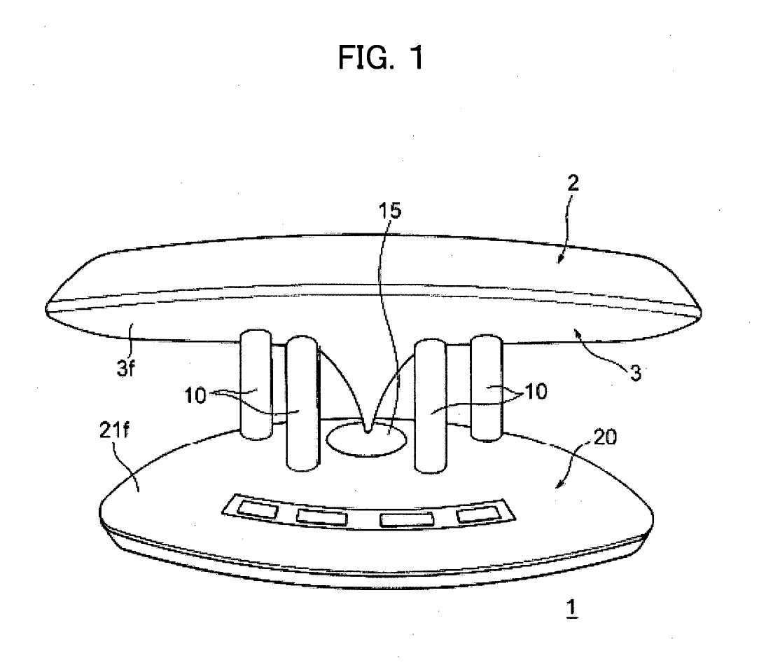

FIG. 1 is a perspective view of an exterior appearance of a speaker system according to an embodiment of the present invention. The speaker system 1 according to the embodiment is, for example, a system combining microphones and a speaker as used in remote conferencing such as teleconferencing. As shown in FIG. 1, the speaker system 1 according to the present embodiment has a cover member 2, a holding member 3, a speaker 15, and a speaker box 20.

The holding member 3 and the speaker box 20 are, for example, formed by acrylonitrile butadiene styrene (ABS) or another plastic. The cover member 2 is provided on the holding member 3 and covers the upper surface of the holding member 3. The cover member 2 is formed by resin fiber or another material which transmits sound and protects the later-described printed circuit board held on the holding member 3 and the microphones. The holding member 3 is supported on the speaker box 20 through a plurality of support members 10 provided on the speaker box 20.

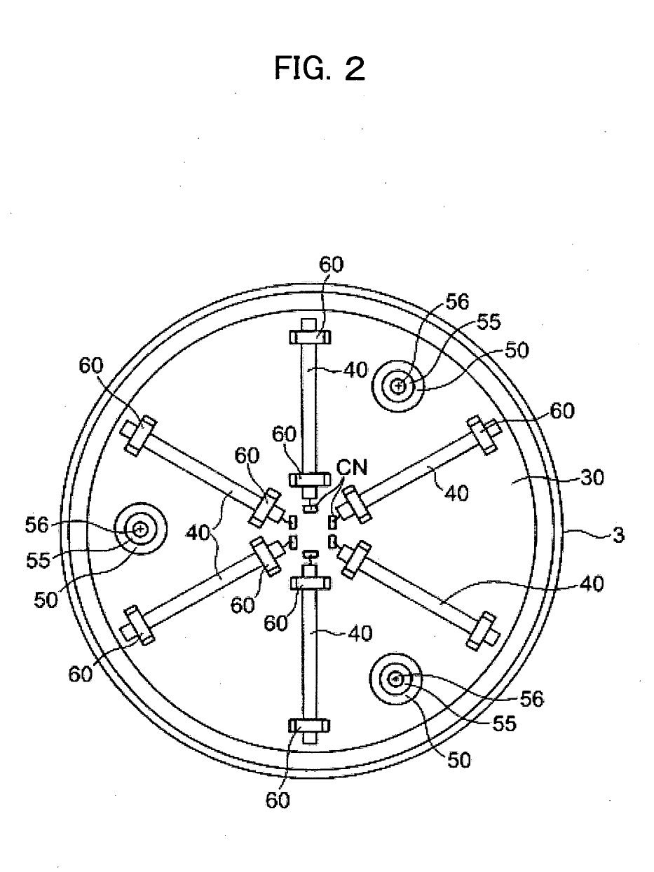

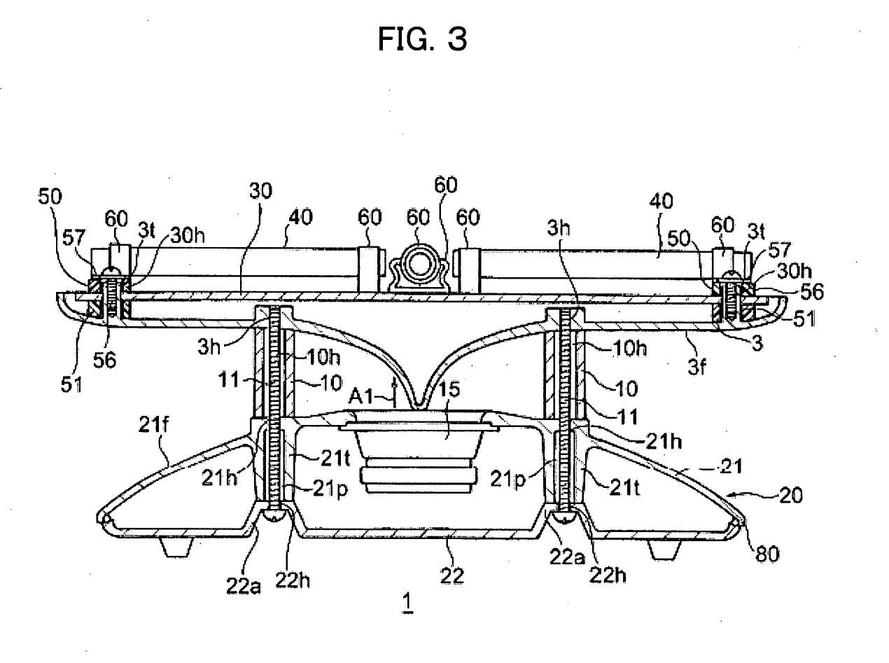

FIG. 2 is a plan view of the holding member 3 in the state with the cover member 2 usually provided on the holding member 3 detached. FIG. 3 is a cross-sectional view of the internal structure of the speaker system according to the present embodiment. As shown in FIG. 2, the holding member 3 has a circular shape and holds the printed circuit board 30 inside the circle.

The printed circuit board 30 is disk shaped. The printed circuit board 30 is provided with a plurality of directional microphones 40. The printed circuit board 30 also carries various types of electronic components (not shown) in addition to the directional microphones 40. The electronic components carried on the printed circuit board 30 form for example an echo canceller circuit, circuits for driving the directional microphones 40 and the later-described speaker, and other circuits required for electrical operations in the speaker system 1.

The plurality of the directional microphones 40 are cylindrical in shape and are arranged radially from the center of the printed circuit board 30, that is, from the center outward in the radial direction, at equal intervals along the circumference. The directional microphones 40 have directivities from the center of the printed circuit board out in the radial direction. The two ends of the directional microphones 40 are supported on the printed circuit board 30 by filter members 60. Note that the filter members 60 are embodiments of a second filter member of the present invention. The filter members 60 are obtained, for example, by molding rubber or a plastic to predetermined shapes. The filter members 60 attenuate vibration propagated from the printed circuit board 30 side.

The back ends of the directional microphones 40 are connected to wires which are in turn connected to the printed circuit board 30 through connectors CN. Due to this, audio signals obtained from the directional microphones 40 are input to the electrical circuits formed on the printed circuit board 30.

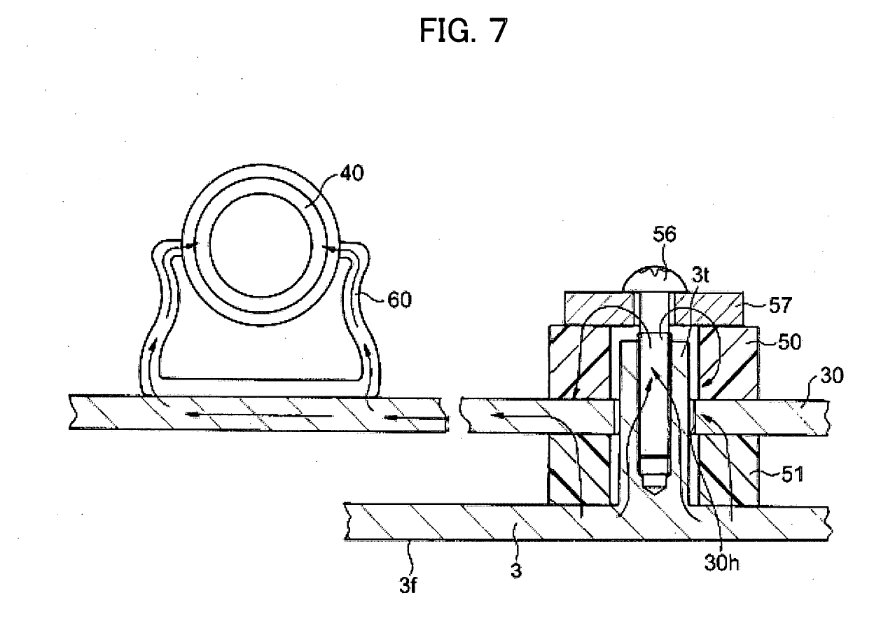

As shown in FIG. 3, the printed circuit board 30 is held on the upper surface of the holding member 3. Specifically, as shown in FIG. 7, shaft parts 3t are integrally formed sticking out from the upper surface of the holding member 3. Ring-shaped filter members 51 are inserted at the shaft parts 3t. The printed circuit board 30 is formed with through holes 30h through which the shaft parts 3t are inserted. The printed circuit board 30 is placed over the filter members 51. Further, ring-shaped filter members 50 are provided around the shaft parts 3t over the printed circuit board 30.

The shaft parts 3t are formed with screw holes at their centers. Screws 56 are inserted into the screw holes via ring-shaped presser plates 57. Therefore, the presser plates 57 press the upper surfaces of the filter members 50. The printed circuit board 30 is clamped between the filter members 50 and the filter members 51. That is, the printed circuit board 30 is supported by the filter members 50 and the filter members 51. Note that the filter members 50 and 51 are embodiments of the first filter member of the present invention. The filter members 50 and 51 are formed by rubber, a plastic, or other material and have similar shapes. Further, the filter members 50 and 51 have different natural frequencies from the filter members 60.

Referring to FIG. 3, the speaker box 20 is comprised of an upper wall plate 21 and a lower wall plate 22. The upper wall plate 21 and the lower wall plate 22 have circular shapes. A single speaker 15 is fixed to the center of the upper wall plate 21. The speaker 15 used is for example a cone speaker. The speaker 15 outputs in a sound output direction A1 shown by an arrow by vibration of a not shown vibration plate along the voice output direction A1.

The speaker box 20 encloses the back of the speaker 15. A seal member 80 is provided between the upper wall plate 21 and the lower wall plate 22. Therefore, the space in the speaker box 20 is an enclosed space.

Support parts 21t extending toward the lower wall plate 22 are integrally formed on the lower surface of the upper wall plate 21. Projecting parts 22a projecting toward the upper wall plate 21 are formed on the upper surface of the lower wall plate 22. The lower end faces of the support parts 21t abut against the upper end faces of the projecting parts 22a. Through holes 21p are formed through the centers of the support parts 21t. The upper ends of the through holes 21p are formed with female threads. The projecting parts 22a are also formed with female threads.

Connection bolts 11 are inserted from the projecting part 22a side into the through holes 21p of the support parts 21t. The connection bolts 11 are screwed into both the female threads 21h formed at the upper wall plate 21 and the female threads 22h formed at the lower wall plate 22. The connection bolts 11 is formed by steel or another metal material and have sufficiently higher rigidity compared with the plastic material forming the speaker box 20 and the holding member 3. Note that the connection bolts 11 are an embodiment of the connection member of the present invention. The connection bolts 11 and the female threads 21h, 22h constitute the restraint means of the present invention which partly restrain relative displacement between the facing wall plates 21 and 22 of the speaker box 20.

The connection bolts 11 pass through the female threads 21h and are screwed into female threads 3h formed at the holding member 3. Therefore, relative displacement is restrained among the female threads 21h of the upper wall plate 21, the lower wall plate 22, and the female threads 3h of the holding member 3. A plurality of support members 10 are provided between the lower surface of the holding member 3 and the upper wall plate 21. The support members 10 are formed with through holes 10h. These through holes 10h receive the connection bolts 11.

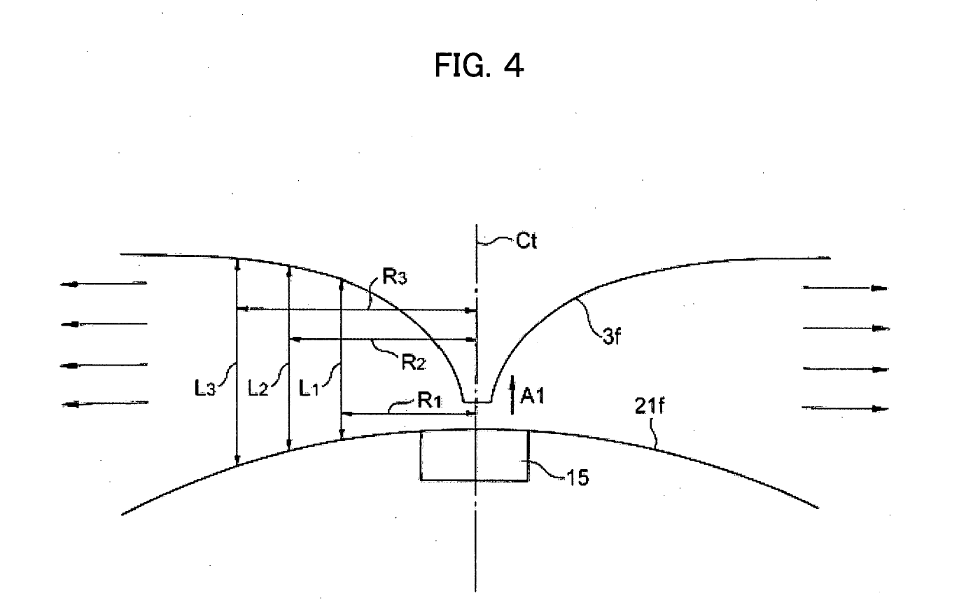

Next, the configuration and action of the reflective (directing) surface 3f of the holding member 3 and the reflective (directing) surface 21f of the speaker box will be described with reference to FIG. 4. The reflective surface 3f constituting the lower surface of the holding member 3 is an embodiment of the first reflective surface of the present invention, while the reflective surface 21f constituting the upper surface of the upper wall plate 21 is an embodiment of the second reflective surface of the present invention.

The reflective surface 3f and the reflective surface 21f disperse sound radially from the speaker 15 in directions substantially perpendicular to the sound output direction A1 of the speaker 15 by reflecting the sound from the speaker 15.

As shown in FIG. 4, the reflective surface 3f is formed by a curved surface projecting smoothly outward toward the speaker 15. The reflective surface 3f is, for example, formed substantially by a rotational curved surface formed by rotating a hyperbolic curve about the center axis Ct of the speaker 15. Similarly, the reflective surface 21f is formed substantially by a rotational curved surface having the center axis Ct of the speaker 15 as its axis of rotation.

R1, R2, and R3 are radii from the center axis Ct of the speaker 15. L1, L2, and L3 are distances between the reflective surface 3f and the reflective surface 21f at R1, R2, and R3 respectively. As will be understood from FIG. 4, the distance between the reflective surface 3f and the reflective surface 21f increases continuously in proportion to the distance from the center axis Ct of the speaker 15.

If the distance between the reflective surface 3f and the reflective surface 21f were constant, resonance would occur at a resonance frequency in accordance with that the constant distance. If resonance occurs, the sound would become very unintelligible and the speech of the participants in the conference would not be able to be faithfully reproduced.

On the other hand, according to the present embodiment, since the distance between the reflective surface 3f and the reflective surface 21f increases continuously in proportion to the distance from the center axis Ct of the speaker 15, the sound output from the speaker 15 will not resonate at a specific frequency. Therefore, it becomes possible to accurately reproduce speech of conference participants. Further, according to the present embodiment, sound output from the speaker 15 is dispersed in directions different from the sound output direction A1 of the speaker 15 without resonating, that is, in all directions (360 degrees radially) in directions substantially perpendicular to the center axis Ct of the speaker 15. Particularly, since a single speaker 15 is used, the sound is dispersed evenly without interference around the center axis Ct. Further, since resonance does not occur between the reflective surface 3f and the reflective surface 21f, it becomes possible to efficiently disperse sound far.

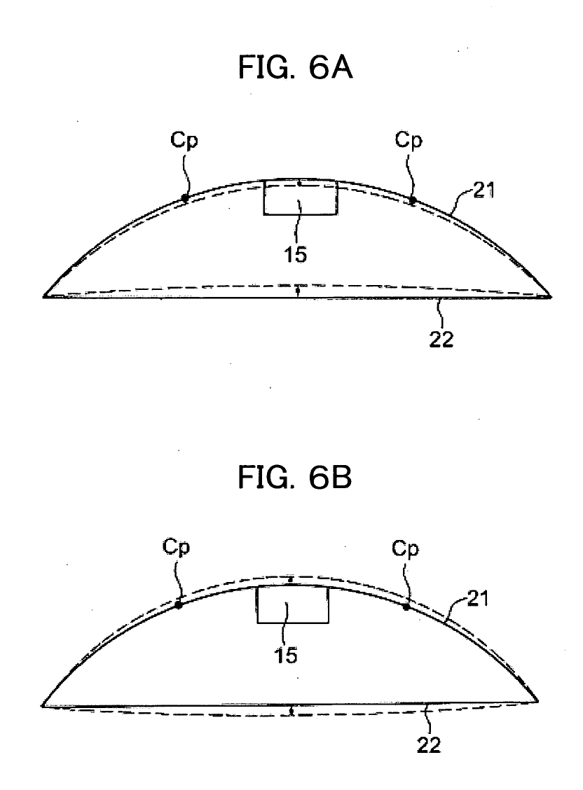

Next, the action and the effect of the connection bolts 11 will be described. FIGS. 6A and 6B are views for explaining an example of vibration of a speaker box in the case of no connection bolts, in which FIG. 6A shows the case in which the sound pressure in the speaker box is low, while FIG. 6B shows the case in which the sound pressure is high. As shown in FIGS. 6A and 6B, if the sound pressure in the speaker box varies, the upper wall plate 21 and the lower wall plate 22 will vibrate in opposite directions. At this time, if the connection positions of the support members 10 to the upper wall plate 21 are Cp, the connection positions Cp will vibrate due to the variation in the sound pressure in the speaker box.

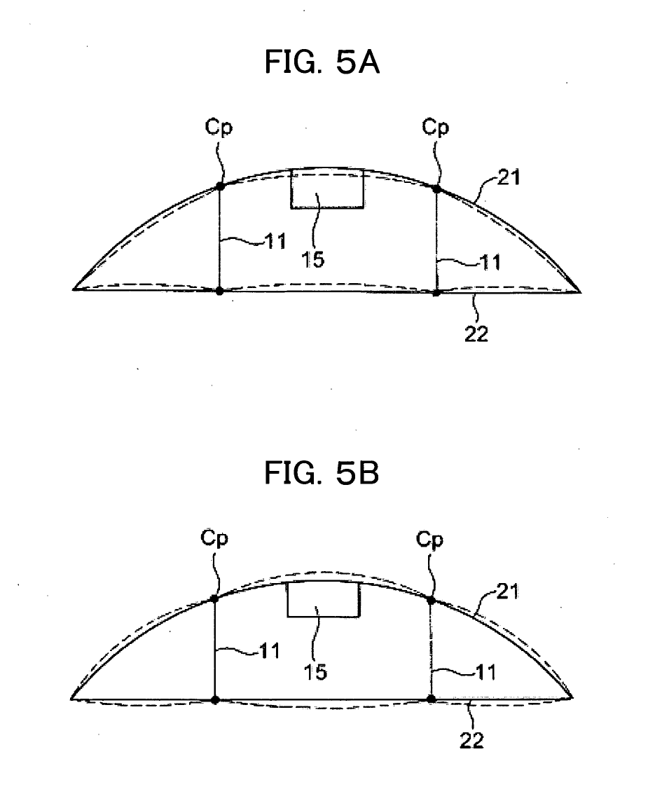

FIGS. 5A and 5B are schematic views of an example of vibration of the speaker box 20 according to the present embodiment. As shown in FIGS. 5A and 5B, the upper wall plate 21 and the lower wall plate 22 are joined by connection bolts 11. If the sound pressure in the speaker box 20 varies, the upper wall plate 21 and the lower wall plate 22 will vibrate in opposite directions, however, the connection positions Cp will not vibrate since they are restrained by the connection bolts 11.

In the present embodiment, since the connection positions Cp are restrained by the connection bolts 11 and do not vibrate much at all, it becomes difficult to transmit vibration to the holding member 3 as it is connected by connection bolts 11 and the support members 10 at those positions. That is, vibration directly propagated from the speaker box 20 to the holding member 3 carrying the microphones 40 is restrained.

The positions restrained by the connection bolts 11 form new nodal points of vibration. That is, since the new nodal points are formed, the vibration frequency of the speaker box 20 increases. By positively utilizing the change of the vibration frequency, it also becomes possible to change the vibration of the speaker box 20 to a vibration of a frequency substantially not influencing the microphones 40. Further, by changing the vibration frequency of the speaker box 20 to a frequency which is easy to attenuate by the filter members 50, 51, 60, etc., it becomes possible to efficiently restrain vibration by the filter members 50, 51, and 60.

Next, the actions and effects of the filter members 50, 51, and 60 will be described with reference to FIG. 7. The vibration from the vibration sources constituted by the speaker 15 and the speaker box 20, as shown in FIG. 7, is propagated for example from the reflective surface 3f of the holding member 3 to the printed circuit board 30 through the filter members 50 and 51. The vibration propagated to the printed circuit board 30 is propagated through the filter member 60 and wires etc. connecting the connectors CN and the microphones 40.

Here, the filter members 50 and 51 support the relatively heavy weight of the printed circuit board 30 and the plurality of the microphones etc. Therefore, the filter members 50 and 51 have the effect of attenuation of vibration of a relatively low frequency. However, it is difficult to attenuate vibration of a relatively high frequency as well. Therefore, the filter members 60 provided between the microphones 40 and the printed circuit board 30 are used attenuate vibration of a relatively high frequency. Since the weight which the filter members 60 support is relatively small, it is possible to relatively easily attenuate vibration of a relatively high frequency.

In this way, since resonance is actively prevented from occurring when sound from the speaker 15 is reflected and dispersed by the reflective surfaces 3f and 21f, vibration of a very wide frequency band is propagated from the speaker 15 to the microphones 40. According to the present embodiment, by combining filter members with different natural frequencies for vibration of this wide frequency band, it becomes possible to attenuate vibration at a wide frequency band.

The present invention is not limited to the above embodiment. In the above embodiment, the reflective surface 3f and the reflective surface 21f were both curved surfaces, however, either the reflective surface 3f or the reflective surface 21f may be a flat surface as well. It is also possible to instead use a fixed surface such as a wall for the reflective surface 21f if affixing the speaker system 1 to a wall etc. Further, in the above embodiments, a case in which the speaker system has the microphones 40 was described, however, the system may also have the speaker 15, the reflective surface 3f, and the reflective surface 21f and not have the microphones 40. Also, in the above embodiment, the case in which the speaker system was used on a table was described, however, the system may also be installed on a ceiling of a domed baseball stadium etc. In this case, the speaker system does not have to have the microphones 40.

1. A speaker system comprising:
a single speaker; and
a sound disperser for dispersing sound radially and evenly from said speaker to directions different from the direction of output of sound of said speaker.

2. A speaker system as set forth in claim 1, wherein said dispersing means comprising:
a first sound directing surface including a concave contour portion perpendicular to the center of the speaker and a flat peripheral portion extending to the end of the concave contour portion, facing the direction of output of sound from said speaker; and
a second sound directing surface arranged facing said first sound directing surface to thereby direct sound to a direction perpendicular to that of the center of the sound output direction of the speaker by cooperating with the first sound directing means.

3. A speaker system as set forth in claim 2, wherein the distance between said first sound directing surface and said second sound directing surface increases continuously along the position from the center of said speaker to the end of the surfaces.

4. A speaker system as set forth in claim 2, wherein second sound directing surfaces is formed substantially by a rotational curved surface having a central axis of said speaker as an axis of rotation.

5. A speaker system as set forth in claim 2,
said system further comprising:
a plurality of directional microphones respectively arranged radially from the center of said speaker, directing all directions,
a holding member for holding said directional microphones, and
a speaker box for sealing the back of said speaker;
wherein said first sound directing surface is formed by the outside surface of said holding member; and
wherein said second sound directing surface is formed by the outside surface of said speaker box.

6. A speaker system as set forth in claim 5, wherein the distance between said first sound directing surface and said second sound directing surface increases continuously along a position from the center of said speaker to the end of the surfaces.

7. A speaker system as set forth in claim 5, wherein said second sound directing surface is formed substantially by a rotational curved surface having the central axis of said speaker as its axis of rotation.

8. A speaker system as set forth in claim 5,
wherein said holding member holds a printed circuit board having circuits for driving said speaker and said directional microphones; and
wherein said directional microphones are supported on said printed circuit board.

9. A speaker system as set forth in claim 8, wherein the distance between said first sound directing surface and said second sound directing surface increases continuously along a position from the center of said speaker to the end of the surfaces.

10. A speaker system as set forth in claim 8, wherein at least one of said first and second sound directing surface is formed substantially by a rotational curved surface having the central axis of said speaker as its axis of rotation.
